(19) United States
(12) Patent Application Publication
(10) Pub. No.: US 2016/0230364 A1
(43) Pub. Date: Aug. 11, 2016

(54) PILE COUPLING FOR HELICAL PILE/TORQUED IN PILE

(71) Applicant: Benjamin G. Stroyer, Webster, NY (US)

(72) Inventor: Benjamin G. Stroyer, Webster, NY (US)

(21) Appl. No.: 15/018,360

(22) Filed: Feb. 8, 2016

Related U.S. Application Data
(60) Provisional application No. 62/112,952, filed on Feb. 6, 2015.

(51) Int. Cl. E02D 5/52; E02D 5/56; F16D 1/02

(52) U.S. Cl. CPC E02D 5/526; F16D 1/02; E02D 5/56

(57) ABSTRACT

A pile includes a first pile section defined by a first end that is configured for engaging a supporting medium and an opposing second end. A second pile section has a first end engageable with the second end of the first pile section, wherein each of the first and second pile sections are defined by mating end fittings that create an interlocking fit. The pile further includes a sleeve that is sized to overlay the first and second engaged ends of the first and second pile sections, the sleeve having at least one through hole aligned with at least one corresponding through hole of the first pile section, the at least one through hole being sized for receiving a fastener for securing the sleeve to the first pile section. In another version, the ends of the pile section can be engaged in contact while the sleeve is defined by a pair of interlocking portions that are attached to the first and second pile sections. Additional pile sections can be sequentially and similarly attached to the second pile section including mating end fittings and overlaying sleeves.

### CROSS REFERENCE TO RELATED APPLICATION

This application claims priority to U.S. Patent Application No. 62/112,952, filed Feb. 6, 2015, the entire contents of which are incorporated by reference.

### TECHNICAL FIELD

This disclosure generally pertains to pile couplings for helical piles or torqued in piles and more specifically to a pile coupling that is configured to better distribute applied torsional loads in use.

### BACKGROUND

Helical or torqued in piles are used in various aspects of construction in order to establish compression or tension resistance in a supporting medium (e.g. soil, rock, etc.). Helical piles, for example, have a helical fighting on a first pile section defined by a pile shaft that is contacted to a surface of the supporting medium. Upon rotation, the helical fighting pulls the first pile section into the supporting medium. After the first pile section has reached a certain depth, a second pile section having a welded or forged coupling, is attached to the first pile section using at least one bolt through formed holes. Rotation of the second pile section applies a torque to the first pile section to continue the rotation and drive the helical pile to a greater depth in the supporting medium. Subsequent pile sections may be sequentially attached to enable the pile to reach a predetermined depth.

Conventional pile couplings are forged or welded to one end of the pile shaft and often are inserted into the second pile section within or around the first pile section and then fastened to the previous pile section together by inserting one or more pins through side holes formed in the pile coupling and the first pile section. Unfortunately, the applied torque that is produced during helical pile installation is significant and will cause elongation in the side holes. Further, the torque transfer depends on the weld at the coupling and weld failure is a recurrent problem. Some known pile couplings incorporate an additional forged end which is provided in order to help transfer the torsion load, but this latter feature is expensive to incorporate and involves additional welding. As a result, an improved pile coupling is therefore desired.

A pile coupling that would transfer a large portion of the torsional load directly down the pile shaft would advantageous, thereby resisting the torque that is to be resisted by the pins alone.

Therefore and according to a first aspect, there is provided a pile assembly comprising a first pile section defined by a first end that is configured for engaging a supporting medium and an opposing second end. A second pile section has a first end engageable with the second end of the first pile section, each of the first and second pile sections having mating end fittings that create an interlocking fit. The pile assembly further includes a sleeve sized to overlay the first and second engaged ends of the first and second pile sections, the sleeve having at least one through hole aligned with at least one corresponding through hole of the first pile section, the at least one through hole being sized for receiving a fastener for securing the sleeve to the first pile section.

According to another aspect, there is provided a pile comprising a first pile section defined by a first end that is configured for engaging a supporting medium and an opposing second end and a second pile section having a first end engageable with the second end of the first pile section. A sleeve is sized to overlay the first and second engaged ends of the first and second pile sections, the sleeve having at least one through hole aligned with at least one corresponding through hole of the first pile section, the at least one through hole being sized for receiving a fastener for securing the sleeve to the first pile section and in which the sleeve is defined by a pair of sleeve sections, each sleeve section having a mated fitting at one end that creates an interlocking fit when the sleeve sections are engaged with one another.

In each of the above, the mated fittings are defined so as to create an interlocking fit between the pile sections or between the sleeve portions, thereby more effectively distributing an applied torsional load.

An advantage realized is that the herein described pile enables greater distribution of an applied torsional load between engaged pile sections, particularly on the fasteners of the pile coupling, thereby ensuring greater reliability and fewer failures or delays.

These and other embodiments, features and advantages will become apparent to those skilled in the art when taken in reference to the following more detailed description of various embodiments of the invention in conjunction with the accompanying drawings that are first briefly described.

### BRIEF DESCRIPTION OF THE DRAWINGS

The accompanying drawings illustrate presently preferred embodiments of the invention and together with the general description give above and the detailed description given below, serve to explain the salient features of the invention.

FIG. 1 is a partial perspective view of a torqued in pile assembly in accordance with an embodiment, partially assembled, the pile including first and second pile sections with each of the pile sections including mated fittings at engageable ends forming a pile coupling;

FIG. 2 is the perspective view of the pile of FIG. 1, still in the partially assembled condition, further depicting a sleeve overlapping the engageable ends of the first and second pile sections;

FIG. 3 is a sectioned end view of the pile depicting the engaged ends of the first and second pile sections; and

FIG. 4 is a perspective view of another torqued in pile made in accordance with another embodiment.

### DETAILED DESCRIPTION

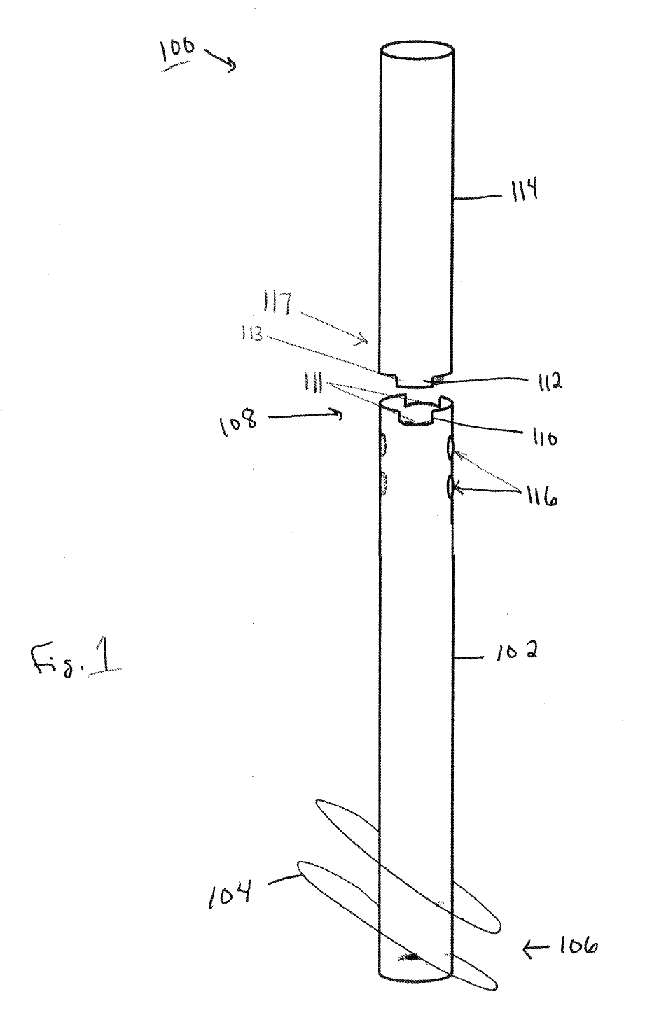

The following discussion relates to a torqued in pile in accordance with certain embodiments. However, the inventive concepts are effective whether the pile is a helical pile having fighting, a bored in pile or a torqued down pile. As shown in FIG. 1, a pile assembly 100 is provided that includes a first pile section 102 and a second pile section 114. Each of the first and second pile sections 102, 114 according to this embodiment are defined by hollow pile shafts, each pile section being made from steel, aluminum or other suitable material. The first pile section 102 according to this embodiment includes a driving tip 104 formed at a distal end 106 that is configured to be driven into a supporting surface (not shown) such as soil, rocks, etc. An opposing proximal end 108 of the first pile section 102 includes a first mated fitting 110 that is monolithically formed in a circumference of the proximal end 108. In the example of FIG. 1, the first mated fitting 110 is preferably defined by a set of precision cuts extending monolithically along the circumference that are sized and configured to match those formed as part of a corresponding mated fitting 112 of the second pile section 114, the latter fitting 112 being formed on the distal end 117 of the second pile section 114. More specifically and when engaged, the mated fittings 110, 112, as configured, produce or create an interlocking fit between the first and second pile sections 102, 114. The types of cuts and the degree of irregularity of the cuts provided in each mated fitting 110, 112 can be varied provided an interlocking fit is created between the pile sections 102, 114 (and also any succeeding pile sections (not shown in this view) sequentially added to the second pile section 114. Preferably, the cuts used to create the mated fittings 110, 112 are formed using precision cutting apparatus. The presently depicted version represents the cuts as matching recesses 111 and axial projections 113, but the formed cuts can be suitably angled and spacially distributed, as needed.

According to this embodiment, the proximal end 108 further comprises at least one through hole 116 that extends through the diameter of the first pile section 102. More specifically and according to this embodiment, two sets of through-holes 116 are present in spaced relation proximate the proximal end 108 of the first pile section 102.

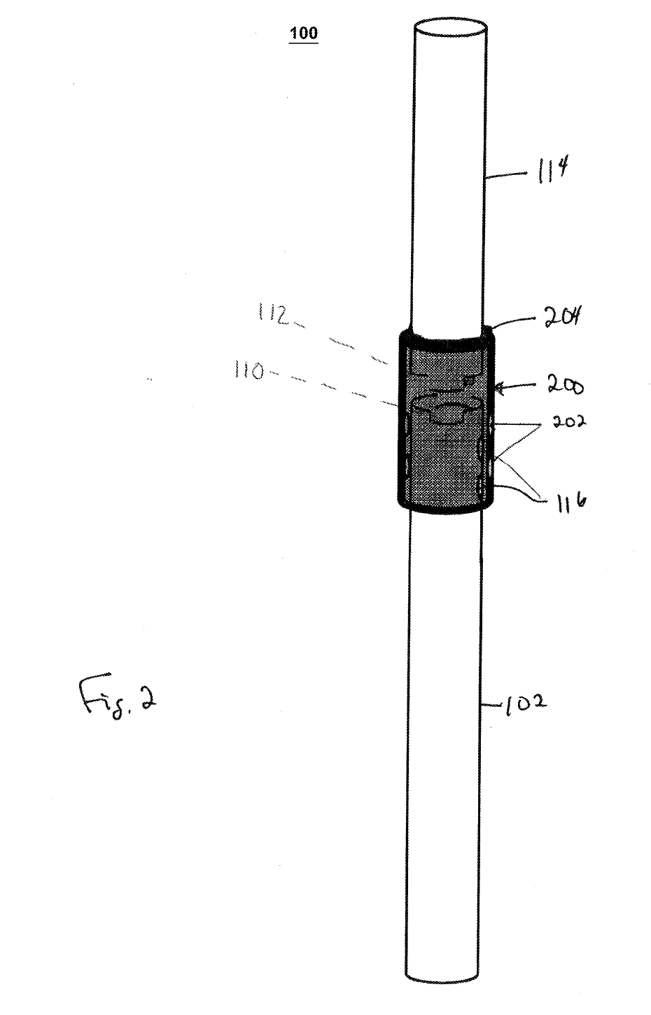

As shown in FIG. 2, a sleeve 200 is disposed about the connection point of the first and second pile sections 102, 114. For illustrative purposes, the first pile section 102 and the second pile section 114 are shown in this figure in an un-connected state though the sleeve 200 is attached following their engagement. According to this embodiment, the sleeve 200 is a hollow cylindrical section made from steel, aluminum or other suitable structural material that is sized to axially overlay the proximal end 108 of the first pile section 102 and the engaged distal end 117 of the second pile section 114 as part of the pile coupling. The sleeve 200 further includes at least one set of corresponding through-holes 202. For purposes of assembly, the sleeve 200 includes two sets of through-holes 202 which are configured and spaced to be aligned with the two sets of through-holes 116 formed on the first pile section 102. A bolt or other fastening member (not shown) is inserted through each aligned sets of through-holes 116, 202. A weld 204 is used to attach the sleeve 200 to the second pile section 114. In some embodiments, a second weld (not shown) may also be used to attach the sleeve 200 to the first pile section 102.

In operation and when a torque is applied to the coupled pile assembly 100, the torsional load is adequately supported by the bolt(s), the weld(s) 204, as well as the mated pile sections 102, 114 due to the inclusion of the sleeve 200 and the interlocking fit created by the mated fittings 110, 112.

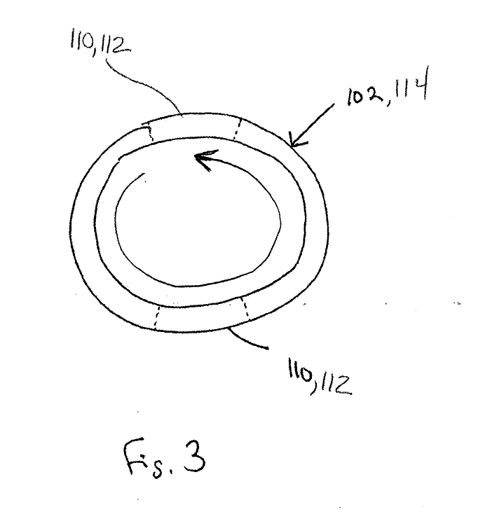

The interlocking configuration between the first and second pile sections 102, 114 provides additional strength and enables better distribution of torsional loads during the pile installation, as shown in the end view of FIG. 3.

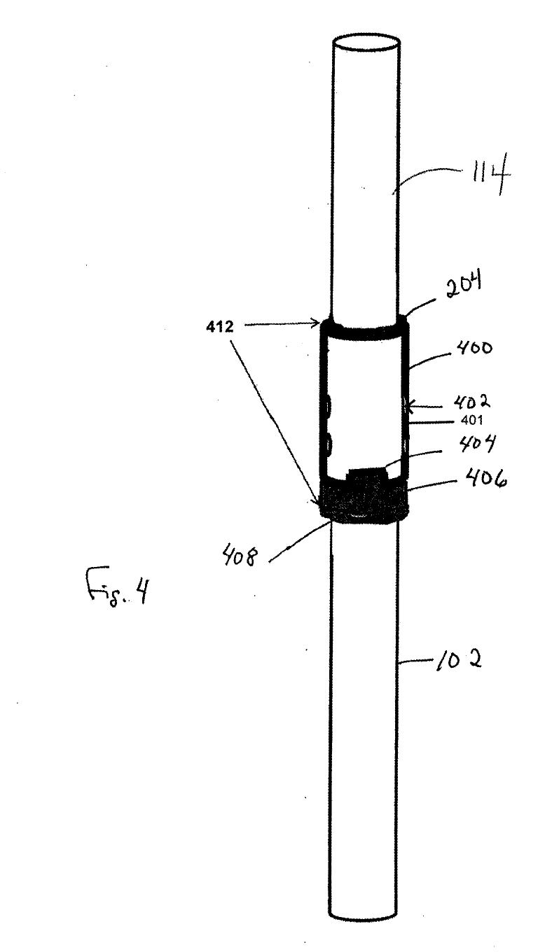

Other embodiments that embody the inventive concepts are possible. A second embodiment is described with reference to FIG. 4. For the sake of clarity, the same reference numbers are used for like parts. In this embodiment, a first pile section 102 and a second pile section 114 are provided. Unlike the prior embodiment, the engaged ends of the first pile section 102 and the second pile section do not include mated fittings and in which the ends of the pile sections are maintained in abutting relation. As in the previous embodiment, a sleeve 400 is assembled in overlaying fashion to the first and second pile sections 102 and 114, respectively. According to this embodiment, however, the sleeve 400 is a hollow substantially cylindrical component that comprises a first sleeve section 401 and a second sleeve section 406. The first sleeve section 401 includes at least set of through holes 402 and a mated fitting 404 at one end. In this specific embodiment, the first sleeve portion 401 has a pair of spaced sets of through holes 402 that are aligned with the through holes 116 of the first pile section 102 in a manner previously discussed wherein each through hole 116, 402 is sized to receive a threaded or riveted connector (not shown).

The second sleeve portion 406 has a corresponding mated fitting 408 that engages the mated fitting 404 defined on the engaged end of the first sleeve portion 401 and creates an interlocking fit therebetween, in a manner akin to that between the first and second pile sections 102, 114 of the prior embodiment. Preferably, the mated fittings 404, 408 are defined by precision cuts monothically made in the circumference at the engaged ends of each sleeve portion 401, 406. In terms of the cuts made, the shape of irregularity of the mated fittings may be varied, with the intent of the formed connection being to transfer torque and relieve the fasteners of the majority of the stress created during installation of the pile as a result of the interlocking fit. The second and first sleeve portions 406, 401 are attached to the first pile section 102 and second pile section 114, respectively, by welds. In operation, the interlocking sleeve portions 401, 406 act to better distribute the torsional load applied to the pile sections.

### PARTS LIST FOR FIGS. 1-4

100 pile assembly
102 first pile section
104 driving tip
106 distal end, first pile section
108 proximal end, first pile section
110 first mated fitting
112 second mated fitting
111 recesses
113 axial projections
114 second pile section
116 through holes, first pile section
117 distal end, second pile section
200 sleeve
202 through holes
204 weld
400 sleeve
401 first sleeve portion
402 through hole
404 mated fitting
406 second sleeve portion
408 mated fitting
412 welds

It will be readily apparent that other variations and modification are possible within the inventive ambits of the present invention, and in accordance with the following claims. For example, the pile sections of the first embodiment could be used in concert with the interlocking sleeve portions according to the embodiment according to FIG. 4.

1. A pile comprising:
a first pile section defined by a first end that is configured for engaging a supporting medium and an opposing second end;
a second pile section having a first end engageable with the second end of the first pile section, each of the first and second pile sections having mating end fittings that create an interlocking fit; and
a sleeve sized to overlay the first and second engaged ends of the first and second pile sections, the sleeve having at least one through hole aligned with at least one corresponding through hole of the first pile section, the at least one through hole being sized for receiving a fastener for securing the sleeve to the first pile section.

2. The pile as recited in claim 1, wherein the mating end fittings are defined by irregular cuts in the circumference of the pile section ends, such that the irregular cuts of the first pile section match those of the second pile section to create the interlocking fit with one another.

3. The pile as recited in claim 1, in which the sleeve is welded to the second pile section.

4. The pile as recited in claim 3, in which the sleeve is welded to the first pile section.

5. The pile as recited in claim 1, wherein the first pile section includes a driving tip.

6. The pile as recited in claim 1, wherein the first pile section includes helical fighting.

7. The pile as recited in claim 1, further comprising an additional pile section sequentially attached to a second end of the second pile section, wherein a first end of the additional pile section and the second end of the second pile section further include mating end fittings that create an interlocking fit when the second and additional pile sections are engaged.

8. The pile as recited in claim 7, further comprising at least one additional sleeve that is sized to overlay the connected ends of the second and additional pile sections, the sleeve including at least one set of through holes for receiving a fastener attached to the second pile section.

9. A pile comprising:
a first pile section defined by a first end that is configured for engaging a supporting medium and an opposing second end;
a second pile section having a first end engageable with the second end of the first pile section; and
a sleeve sized to overlay the first and second engaged ends of the first and second pile sections, the sleeve having at least one through hole aligned with at least one corresponding through hole of the first pile section, the at least one through hole being sized for receiving a fastener for securing the sleeve to the first pile section and in which the sleeve is defined by a pair of sleeve sections, each sleeve section having a mating fitting at one end that creates an interlocking fit when the sleeve sections are engaged with one another.

10. The pile as recited in claim 6, in which the mating ends are defined by irregular cuts in the circumference of each engaging part of the sleeve that create the interlocking fit.

11. The pile as recited in claim 10, wherein one of the sleeve portions is welded to the first pile section and the other sleeve portion is welded to the second pile section.

12. The pile as recited in claim 9, wherein the first pile section includes a driving tip.

13. The pile as recited in claim 9, wherein the first pile section includes helical fighting.

14. The pile as recited in claim 1, further comprising:
an additional pile section sequentially attached to a second end of the second pile section, wherein a first end of the additional pile section and the second end of the second pile section are engaged; and
at least one additional sleeve that is sized to overlay the connected ends of the second and additional pile section, the sleeve including at least one set of through holes for receiving a fastener attached to the second pile section and in which the at least one additional sleeve is defined by a pair of engaged sleeve sections, each sleeve section having a mating fitting at one end that creates an interlocking fit when engaged.
